(19) United States
(12) Patent Application Publication
(10) Pub. No.: US 2026/0137066 A1
(43) Pub. Date: May 21, 2026

(54) CIRCULATING AQUARIUM HEATER HAVING SPIRAL ALLOY HEATING TUBE AND WATER GUIDING AND PUMPING STRUCTURE

(71) Applicant: Shenzhen Mago Trading Co.,LTD, Shenzhen (CN)

(72) Inventor: Mingbo Cao, Shenzhen (CN)

(21) Appl. No.: 19/447,025

(22) Filed: Jan. 13, 2026

(30) Foreign Application Priority Data
Jan. 14, 2025 (CN) 202520075093.8

(51) Int. Cl. A01K 63/06; A01K 63/04

(52) U.S. Cl. CPC A01K 63/065; A01K 63/047

(57) ABSTRACT

A circulating aquarium heater having a spiral alloy heating tube and a water guiding and pumping structure includes a housing, where the housing includes an upper body cover and a lower body cover that are snap-connected to form an internal cavity, the upper body cover and the lower body cover are fixed by a fixing base, and a plurality of suction cups are snap-connected to a lower end of the fixing base; and a spiral heating tube, where the spiral heating tube is fixedly nested between the upper body cover and the lower body cover, the spiral heating tube is correspondingly disposed on one side of an inner top of the upper body cover, and the spiral heating tube is made of nickel alloy or nickel-based alloy.

### TECHNICAL FIELD

The present disclosure relates to the technical field of aquarium equipment, and in particular to a circulating aquarium heater integrating heating and circulation, and having a spiral alloy heating tube and a water guiding and pumping structure.

### BACKGROUND

Aquarium heaters are heating devices specifically designed for aquariums, and are primarily used to maintain suitable living temperatures for fish. The aquarium heaters generate high temperatures with electric energy, and their main working principles are to convert the electric energy into thermal energy, and transfer the thermal energy to water through heating elements. Through the heating elements, the aquarium heaters raise water temperatures and maintain the temperatures constant, thereby providing the suitable living environments for the fish.

Existing aquarium heaters typically use rod-shaped heating elements, with heating rods directly immersed in water for heating. However, this heating method has certain drawbacks. Firstly, to improve heating efficiency, large heating rods are used, which not only compromise the aesthetics of the aquariums, but also occupy the effective space of the aquariums to hinder the activities of fish. Secondly, the heating rods cannot actively circulate water in the aquariums, resulting in uneven heating of the water. Specifically, the temperature of the water close to the heating rods is excessively high, while the temperature of the water away from the heating rods is excessively low, thereby being detrimental to the growth of fish. Finally, the electrical connecting portions are located in a high-humidity environment. In case of an unreliable sealing structure, water ingress may occur to increase the maintenance cost.

Therefore, an aquarium heating solution with a more compact structure, higher heating efficiency, active circulation, and a more reliable waterproof structure at the wire outlet/electrical connecting portions is desired to solve the problems in the background art.

### SUMMARY

An objective of the present disclosure is to provide a circulating aquarium heater having a spiral alloy heating tube and a water guiding and pumping structure, so as to solve problems of low heating efficiency, large size, poor aesthetics, uneven heating due to no active circulation, and insufficient waterproof reliability at the wire outlet portion. The present disclosure improves the heating efficiency, reduces the product size, does not compromise the aesthetics of the aquarium, and can evenly heat water in the aquarium.

To achieve the above objective, the present disclosure provides the following technical solutions:

A circulating aquarium heater having a spiral alloy heating tube and a water guiding and pumping structure includes:

a housing, where the housing includes an upper body cover and a lower body cover that are snap-connected to form an internal cavity, the upper body cover and the lower body cover are fixed by a fixing base, and a plurality of suction cups are snap-connected to a lower end of the fixing base;

a spiral heating tube, where the spiral heating tube is fixedly nested between the upper body cover and the lower body cover, the spiral heating tube is correspondingly disposed on one side of an inner top of the upper body cover, and the spiral heating tube is made of nickel alloy or nickel-based alloy;

a motor assembly that includes a motor enclosure fixedly disposed on one side of an inner bottom of the lower body cover and a motor disposed in the motor enclosure, where the motor enclosure is fixedly nested between the upper body cover and the lower body cover, and located on an end opposite to the spiral heating tube;

a water impeller that is fixedly connected to an output end of the motor;

a water guiding tube, where the water guiding tube is fixedly sleeved on an outer surface of the water impeller and connected to the motor enclosure through a fastener, such that the water impeller is at least partially covered in the water guiding tube; the water guiding tube is fixedly nested between the upper body cover and the lower body cover, is close to one side of the spiral heating tube, and is configured to form a guiding channel, such that outside cold water pumped into the internal cavity flows along a region close to the spiral heating tube, and is heated; and a water outlet direction of the water guiding tube is upward, so as to disturb a water surface to form a wave effect;

a sealed wire outlet assembly that is disposed in a groove at a center of a top end of the upper body cover, and includes a silicone gasket nested in the groove, a potting enclosure snap-connected to the upper body cover and nested in the silicone gasket, a water isolation plate box disposed on one side of an interior of the potting enclosure, and a wire outlet cover disposed on a top end of the potting enclosure; and

two side covers, where the two side covers are respectively snap-connected to two sides of the upper body cover and the lower body cover, and are configured to respectively seal openings at two ends of the housing.

Further, the fastener is a bolt, a buckle, or a threaded connector, such that the water guiding tube is fixedly connected to the motor enclosure in a detachable manner.

Further, the spiral heating tube has a spiral pitch of 5-20 mm, and a spiral diameter matching with an inner diameter of the housing, ensuring that water can fully contact a surface of the spiral heating tube.

Further, the motor enclosure uses a waterproof sealing structure, with an outer surface closely attached to an inner wall of the upper body cover and an inner wall of the lower body cover, realizing fixation and positioning.

Further, the water impeller is a three-blade or five-blade structure, and is made of corrosion-resistant plastic or alloy, and a gap between a rotational radius of the water impeller and an inner diameter of the water guiding tube is 1-3 mm.

Further, the water guiding tube includes a water inlet end provided with a flared structure, and a water outlet end provided with an inclined guiding surface, so as to optimize water pumping efficiency as well as stability in a water outlet direction.

Further, the silicone gasket is made of food-grade silicone, and has a stepped cross-section, forming a double seal with the groove of the upper body cover and an outer wall of the potting enclosure.

Further, the potting enclosure is filled with a waterproof insulating glue, and a water isolation and protection sensor configured to detect whether the circulating aquarium heater is separated from the water surface and trigger power-off protection is disposed in the water isolation plate box.

Further, the fixing base is integrally formed, and is fixed with the upper body cover and the lower body cover through a clamping groove or a bolt, ensuring that the housing is structurally stable.

Further, a plurality of water permeable holes are formed in each of the two side covers; and the water permeable holes have apertures of 2-5 mm, and are configured to realize circulation between aquarium water inside the housing and aquarium water outside the housing.

The present disclosure has the following beneficial effects:

1. The circulating aquarium heater having a spiral alloy heating tube and a water guiding and pumping structure provided by the present disclosure adopts the spiral nickel-alloy heating tube as the heating element, which greatly improves the heating efficiency. While eliminating the large spiral heating tube, the present disclosure neither compromises the aesthetics of the aquarium nor occupies the effective space of the aquarium, thereby providing a more spacious living environment for the fish.

2. Since the motor enclosure is disposed on the end of the housing opposite to the spiral heating tube, the motor is disposed in the motor enclosure, and the motor drives the water impeller to rotate, the present disclosure can actively circulate the water in the aquarium, and evenly heat the water, preventing the situation where the temperature of the water close to the spiral heating tube is excessively high, while the temperature of the water away from the spiral heating tube is excessively low, and providing a more suitable growing environment for the fish.

3. With the combination of the silicone gasket, the potting enclosure (sealable), and the water isolation structure, the present disclosure enhances waterproof reliability of the wire outlet/electrical connecting portion.

4. The circulating aquarium heater having a spiral alloy heating tube and a water guiding and pumping structure provided by the present disclosure has a compact overall structure and a small size, being aesthetically pleasing and convenient to mount and use. The circulating aquarium heater having a spiral alloy heating tube and a water guiding and pumping structure is fixed with the suction cups, and can be fixed at any position of the aquarium, achieving great convenience in use, and adapting to aquariums of various specifications. The spiral heating tube made of the nickel alloy exhibits excellent corrosion resistance, ensuring a long service life and a low maintenance cost. By generating waves, the present disclosure not only circulates the water, but also adds a sense of dynamism to the aquarium, creating a more natural aquatic environment for the fish. The present disclosure effectively solves the problems of the conventional aquarium heater in low heating efficiency, large size, poor aesthetics, and uneven water heating due to no active circulation, and provides a more suitable growing environment for the fish.

### BRIEF DESCRIPTION OF THE DRAWINGS

FIG. 1 is a schematic front view according to the present disclosure;

FIG. 2 is a schematic exploded view according to the present disclosure;

FIG. 3 is a schematic view of a fixing base and a suction cup according to the present disclosure;

FIG. 4 is a schematic view of an upper body cover according to the present disclosure;

FIG. 5 is a schematic view of a spiral heating tube, a water guiding tube, a water impeller, and a motor enclosure according to the present disclosure;

### Reference numerals:

1: housing,

2: motor assembly,

3: fastener,

4: sealed wire outlet assembly,

5: wire outlet cover,

6: water isolation plate box,

7: potting enclosure,

8: silicone gasket,

9: upper body cover,

10: side cover,

11: motor enclosure,

12: water impeller,

13: lower body cover,

14: fixing base,

15: suction cup,

16: spiral heating tube,

17: water guiding tube, and

18: motor.

### DETAILED DESCRIPTION OF THE EMBODIMENTS

The technical solutions in embodiments of the present disclosure will be described below clearly and completely with reference to the accompanying drawings in the embodiments of the present disclosure. Apparently, the described embodiments are merely some, rather than all of the embodiments of the present disclosure. All other embodiments obtained by those of ordinary skill in the art based on embodiments of the present disclosure without creative efforts shall fall within the protection scope of the present disclosure.

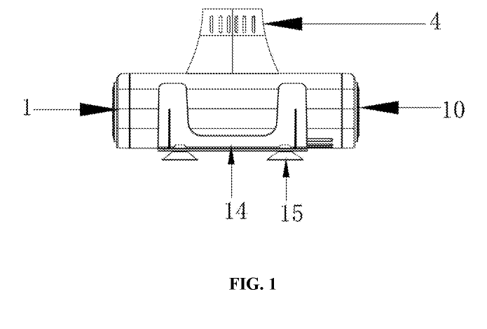

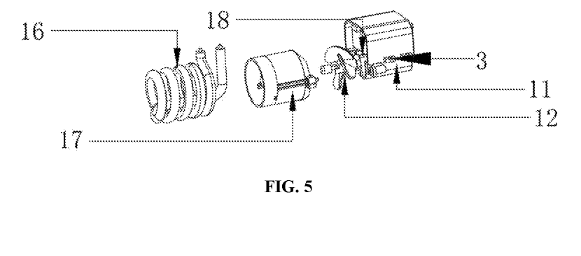

Referring to FIGS. 1-5, an embodiment of the present disclosure provides a circulating aquarium heater having a spiral alloy heating tube and a water guiding and pumping structure.

The circulating aquarium heater having a spiral alloy heating tube and a water guiding and pumping structure includes an upper body cover 9, a lower body cover 13, two side covers 10, and a fixing base 14. A spiral heating tube 16 is disposed on one side of an inner top of the upper body cover 9. A motor enclosure 11 is fixedly connected to one side of an inner bottom of the lower body cover 13 through a screw. A water impeller 12 is fixedly connected to an output end of the motor 18. A water guiding tube 17 is fixedly sleeved on an outer surface of the water impeller 12.

The spiral heating tube 16 is located on one end of a housing 1, while the motor enclosure 11 is located on an opposite end/opposite side of the housing 1.

The water guiding tube 17 covers the water impeller 12 to form a guiding channel.

The water guiding tube 17 is fixedly connected to the motor enclosure 11 through a screw. The two side covers 10 are respectively snap-connected to two sides of the upper body cover 9 and the lower body cover 13. The upper body cover 9 is snap-connected to the lower body cover 13. An outer surface of the spiral heating tube 16 is fixedly nested between the upper body cover 9 and the lower body cover 13. An outer surface of the motor enclosure 11 is fixedly nested between the upper body cover 9 and the lower body cover 13. An outer surface of the water guiding tube 17 is fixedly nested between the upper body cover 9 and the lower body cover 13. The water guiding tube 17 is located near one side of the spiral heating tube 16. The two side covers 10 have a same shape and a same size. The spiral heating tube 16 is made of nickel alloy.

Specifically, the spiral heating tube 16 is disposed on one side of the inner top of the upper body cover 9. The water guiding tube 17 is connected to one side of the motor enclosure 11 through the screw, such that the water impeller 12 is covered in the water guiding tube 17. The motor enclosure 11 is fixedly connected to the inner bottom of the body cover plate through the screw. One side of the water guiding tube 17 faces the spiral heating tube 16. The upper body cover 9 is snap-connected to the lower body cover 13 to form a body. The two side covers 10 are respectively snap-connected to two sides of the body. In use, a motor 18 in the motor enclosure 11 drives the water impeller 12 to rotate. The water impeller 12 generates a centrifugal force during rotation, pumping outside cold water into the body. After being heated by the spiral heating tube 16, the cold water is discharged from one side and then pumped again into the body from another side, thereby forming circulation. Therefore, the water can be evenly heated, preventing the situation where the temperature of the water close to the spiral heating tube 16 is excessively high, while the temperature of the water away from the spiral heating tube 16 is excessively low. The aquarium heater has a compact overall structure and a small size, being aesthetically pleasing and convenient to mount and use.

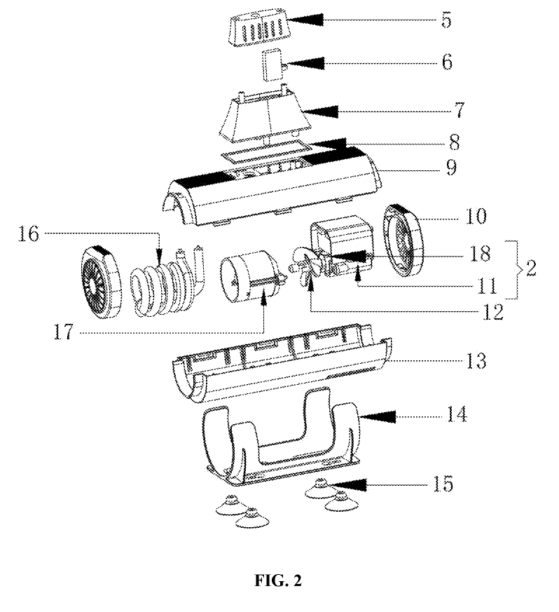

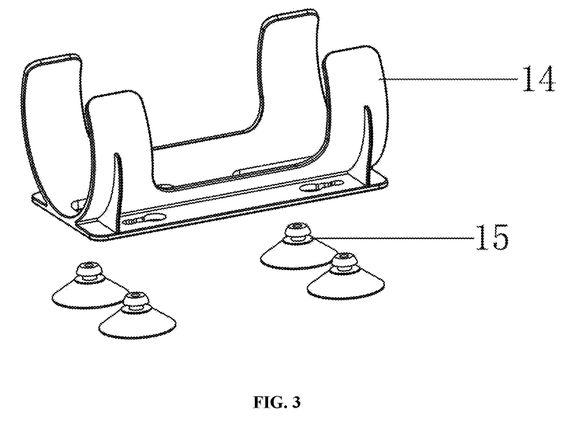

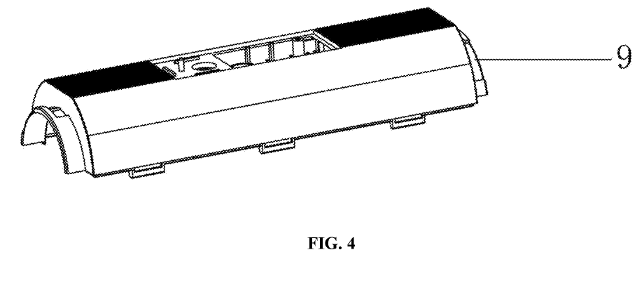

Referring to FIG. 2, FIG. 3, and FIG. 4, a silicone gasket 8 is disposed in a groove at a center of a top end of the upper body cover 9. A potting enclosure 7 is disposed in the silicone gasket 8. One side of an interior of the potting enclosure 7 is provided with a water isolation plate box 6. A top end of the potting enclosure 7 is provided with a wire outlet cover 5. The potting enclosure 7 is snap-connected to the upper body cover 9. A sealant may be filled in the potting enclosure to form sealing and insulation for an electrical connecting portion. The water isolation plate box 6 is configured to isolate a potential water ingress path, reducing a possibility that water vapor or liquid water directly contacts an electrical connecting region.

The fixing base 14 is configured to fix the upper body cover 9 and the lower body cover 13. A plurality of suction cups 15 are snap-connected to a lower end of the fixing base 14, such that the heater is detachably disposed on a wall surface of an aquarium.

In assembly, the spiral heating tube 16 is disposed on one side of the inner top of the upper body cover 9. The water guiding tube 17 is connected to one side of the motor enclosure 11 through the fastener 3, such that the water impeller 12 is located in the water guiding tube 17. The motor enclosure 11 is fixed on the inner bottom of the lower body cover 13. The upper body cover 9 is snap-connected/connected to the lower body cover 13 to form the body, with the two sides respectively provided with the side covers 10.

The working principle is as follows: The circulating aquarium heater having a spiral alloy heating tube and a water guiding and pumping structure is disposed on the aquarium through the suction cups 15, and is powered on to start the motor 18. The motor 18 in the motor enclosure 11 drives the water impeller 12 to rotate. The water impeller 12 generates a centrifugal force during rotation, pumping outside cold water into the body. Under the guidance of the water guiding tube 17, pumped water is discharged from one side of the device after passing through a heating region of the spiral heating tube 16 along a predetermined channel, and is pumped again into the body from another side of the device, thereby forming the circulation. Because of the spiral nickel alloy heating tube 16, the circulating aquarium heater achieves high heating efficiency and small size, without compromising the aesthetics of the aquarium. Meanwhile, the rotation of the water impeller 12 can actively circulate the water, such that the water is evenly heated, preventing the situation where the temperature of the water close to the spiral heating tube 16 is excessively high, while the temperature of the water away from the spiral heating tube 16 is excessively low. The present disclosure effectively solves the problems of the conventional aquarium heater in low heating efficiency, large size, poor aesthetics, and uneven water heating due to no active water circulation, and provides a more suitable growing environment for the fish.

Finally, it should be noted that the above are only preferred embodiments of the present disclosure and are not intended to limit the present disclosure. Although the present disclosure has been described in detail with reference to the above embodiments, those skilled in the art can still modify the technical solutions described in the above embodiments, or equivalently substitute some of the technical features of the embodiments. Any modifications, equivalent substitutions, improvements, and the like within the spirit and principle of the present disclosure should fall within the protection scope of the present disclosure.

What is claimed is:

1. A circulating aquarium heater having a spiral alloy heating tube and a water guiding and pumping structure, comprising:
a housing (1), wherein the housing (1) comprises an upper body cover (9) and a lower body cover (13) that are snap-connected to form an internal cavity, the upper body cover (9) and the lower body cover (13) are fixed by a fixing base (14), and a plurality of suction cups (15) are snap-connected to a lower end of the fixing base (14);
a spiral heating tube (16), wherein the spiral heating tube (16) is fixedly nested between the upper body cover (9) and the lower body cover (13), the spiral heating tube (16) is correspondingly disposed on one side of an inner top of the upper body cover (9), and the spiral heating tube (16) is made of nickel alloy or nickel-based alloy;
a motor assembly (2) that comprises a motor enclosure (11) fixedly disposed on one side of an inner bottom of the lower body cover (13) and a motor (18) disposed in the motor enclosure (11), wherein the motor enclosure (11) is fixedly nested between the upper body cover (9) and the lower body cover (13), and located on an end opposite to the spiral heating tube (16);
a water impeller (12) that is fixedly connected to an output end of the motor (18);
a water guiding tube (17), wherein the water guiding tube (17) is fixedly sleeved on an outer surface of the water impeller (12) and connected to the motor enclosure (11) through a fastener (3), such that the water impeller (12) is at least partially covered in the water guiding tube (17); the water guiding tube (17) is fixedly nested between the upper body cover (9) and the lower body cover (13), is close to one side of the spiral heating tube (16), and is configured to form a guiding channel, such that outside cold water pumped into the internal cavity flows along a region close to the spiral heating tube (16), and is heated; and a water outlet direction of the water guiding tube (17) is upward, so as to disturb a water surface to form a wave effect;
a sealed wire outlet assembly (4) that is disposed in a groove at a center of a top end of the upper body cover (9), and comprises a silicone gasket (8) nested in the groove, a potting enclosure (7) snap-connected to the upper body cover (9) and nested in the silicone gasket (8), a water isolation plate box (6) disposed on one side of an interior of the potting enclosure (7), and a wire outlet cover (5) disposed on a top end of the potting enclosure (7); and
two side covers (10), wherein the two side covers (10) are respectively snap-connected to two sides of the upper body cover (9) and the lower body cover (13), and are configured to respectively seal openings at two ends of the housing (1).

2. The circulating aquarium heater according to claim 1, wherein the fastener (3) is a bolt, a buckle, or a threaded connector, such that the water guiding tube (17) is fixedly connected to the motor enclosure (11) in a detachable manner.

3. The circulating aquarium heater according to claim 1, wherein the spiral heating tube (16) has a spiral pitch of 5-20 mm, and a spiral diameter matching with an inner diameter of the housing (1), ensuring that water fully contacts a surface of the spiral heating tube.

4. The circulating aquarium heater according to claim 1, wherein the motor enclosure (11) uses a waterproof sealing structure, with an outer surface closely attached to an inner wall of the upper body cover (9) and an inner wall of the lower body cover (13), realizing fixation and positioning.

5. The circulating aquarium heater according to claim 1, wherein the water impeller (12) is a three-blade or five-blade structure, and is made of corrosion-resistant plastic or alloy, and a gap between a rotational radius of the water impeller (12) and an inner diameter of the water guiding tube (17) is 1-3mm.

6. The circulating aquarium heater according to claim 1, wherein the water guiding tube (17) comprises a water inlet end provided with a flared structure, and a water outlet end provided with an inclined guiding surface, so as to optimize water pumping efficiency as well as stability in a water outlet direction.

7. The circulating aquarium heater according to claim 1, wherein the silicone gasket (8) is made of food-grade silicone, and has a stepped cross-section, forming a double seal with the groove of the upper body cover (9) and an outer wall of the potting enclosure (7).

8. The circulating aquarium heater according to claim 1, wherein the potting enclosure (7) is filled with a waterproof insulating glue, and a water isolation and protection sensor configured to detect whether the circulating aquarium heater is separated from the water surface and trigger power-off protection is disposed in the water isolation plate box (6).

9. The circulating aquarium heater according to claim 1, wherein the fixing base (14) is integrally formed, and is fixed with the upper body cover (9) and the lower body cover (13) through a clamping groove or a bolt, ensuring that the housing (1) is structurally stable.

10. The circulating aquarium heater according to claim 1, wherein a plurality of water permeable holes are formed in each of the two side covers (10); and the water permeable holes have apertures of 2-5 mm, and are configured to realize circulation between aquarium water inside the housing and aquarium water outside the housing (1).
